(19) United States
(12) Patent Application Publication
(10) Pub. No.: US 2025/0304877 A1
(43) Pub. Date: Oct. 2, 2025

(54) LUBRICANT COMPOSITION AND METHOD OF PREPARING AN ETHYLENE-BASED POLYMER USING THE SAME

(71) Applicants: SK INNOVATION CO., LTD., Seoul (KR); SK GEO CENTRIC CO., LTD., Seoul (KR)

(72) Inventors: Ho Seong LEE, Seoul (KR); Ji Hye PARK, Seoul (KR); Won Bin KIM, Seoul (KR)

(21) Appl. No.: 19/093,180

(22) Filed: Mar. 27, 2025

(30) Foreign Application Priority Data
Apr. 2, 2024 (KR) 10-2024-0044694

(51) Int. Cl. C10M 169/04; C08F 10/02; C10M 101/02; C10M 129/40; C10M 137/08; C10M 141/10; C10N 30/06; C10N 40/30

(52) U.S. Cl. CPC C10M 169/04; C08F 10/02; C10M 101/02; C10M 129/40; C10M 137/08; C10M 141/10; C10M 2203/1006; C10M 2207/126; C10M 2223/043; C10N 2030/06; C10N 2040/30

(57) ABSTRACT

A lubricant composition according to embodiments of the present disclosure may include a base oil, a friction-reducing agent which includes oleic acid, and an antiwear agent which includes a phosphoric acid compound. The friction-reducing agent may be included in the lubricant composition in a predetermined amount such as an amount of 0.02 wt % to 0.9 wt % based on a total weight of the lubricant composition.

### CROSS-REFERENCE TO RELATED APPLICATION

This patent application claims the priority and benefits of Korean patent application No. 10-2024-0044694, filed on Apr. 2, 2024, the disclosure of which is incorporated herein by reference in its entirety.

### BACKGROUND

### 1. Field of the Invention

The embodiments of the present disclosure relate generally to a lubricant composition and a method of preparing an ethylene-based polymer using the same. More specifically, it concerns a lubricant composition including a base oil, and a method of preparing an ethylene-based polymer using the lubricant composition.

### 2. Description of the Related Art

An ethylene-based polymer is utilized for various applications such as a sealing material, an adhesive, a packing material, an optical film and the like. The ethylene-based polymer may include, for example, an ethylene-carboxylic acid copolymer, an ethylene-(meth)acrylate copolymer, an ethylene-acetate copolymer, polyethylene and the like.

The ethylene-based polymer may be prepared by polymerizing ethylene and/or a comonomer (e.g., carboxylic acid, acrylate, acetate, etc.) through high-pressure equipment such as a pump, a compressor or the like.

However, due to a high reactivity of the ethylene and/or the comonomer, self-polymerization may occur when exposed to high temperature and pressure in a process of supplying the ethylene or comonomer to a reactor through the high-pressure equipment. Self-polymerization refers to the unintended polymerization of the ethylene (or of the comonomer) molecules before they reach the reactor. This can happen when the ethylene (or the comonomer) is exposed to high temperatures and pressures during the process of being supplied to the reactor and is starting to polymerize by itself before it reaches the reactor.

When the ethylene and/or the comonomer is self-polymerized, equipment defects such as clogging, plugging, and flow path blocking of the above-described high-pressure equipment may occur. Therefore, a production yield of the copolymer may be decreased and it may be difficult to uniformly repeat the process.

Accordingly, an improved solution for mitigating or effectively preventing these plugging issues and equipment defects would be highly desirable. For example, various methods of using an oxidation stabilizer suppressing equipment defects such as clogging, plugging, and flow path blocking are being studied. However, no effective solution has been implemented to date, and significant research and development efforts are being invested in developing a solution that effectively prevents plugging and equipment defects.

### SUMMARY

An embodiment of the present disclosure provides a lubricant composition that enhances wear resistance, polymerization efficiency and process stability.

Another embodiment of the present disclosure provides a method of preparing an ethylene-based polymer using the lubricant composition.

According to an embodiment of the present disclosure, there is provided a lubricant composition including a base oil; a friction-reducing agent which includes oleic acid; and an antiwear agent which includes a phosphoric acid compound, wherein a content of the friction-reducing agent is 0.02% by weight to 0.9% by weight based on a total weight of the lubricant composition.

In some embodiments, the base oil may include a white mineral oil (also known as liquid paraffin).

In some embodiments, the content of the friction-reducing agent may be 0.1% by weight to 0.8% by weight based on the total weight of the lubricant composition.

In some embodiments, the phosphoric acid compound may include an amine group.

In some embodiments, the phosphoric acid compound may include a compound represented by Formula 1 below:

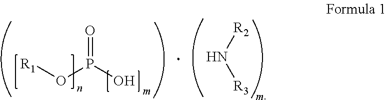

In Formula 1, each of R¹ to R³ may independently be an alkyl group with 1 to 30 carbon atoms.

In Formula 1, each of n and m may independently be 1 or 2, and a sum of n and m may be 3.

In some embodiments, a content of the antiwear agent may be 0.01% by weight to 0.5% by weight based on the total weight of the lubricant composition.

In some embodiments, the content of the antiwear agent is 0.2% by weight to 0.4% by weight based on the total weight of the lubricant composition.

According to another embodiment of the present disclosure, there is provided a method of preparing an ethylene-based polymer including injecting the lubricant composition according to claim 1 into a compression device; moving a monomer for preparing an ethylene-based polymer which includes an ethylene monomer to a reactor through the compression device; and reacting the monomer for preparing an ethylene-based polymer in the reactor.

In some embodiments, the monomer for preparing an ethylene-based polymer may further include at least one selected from the group consisting of a carboxylic acid monomer, a (meth)acrylate monomer and an acetate monomer.

In some embodiments, the ethylene-based polymer may include at least one selected from the group consisting of an ethylene-carboxylic acid copolymer, an ethylene-(meth)acrylate copolymer, an ethylene-acetate copolymer and polyethylene.

According to an embodiment of the present disclosure, there is provided a lubricant composition including a base oil comprising a white mineral oil; a friction-reducing agent which comprises oleic acid; and an antiwear agent which comprises a phosphoric acid compound having the following Formula 1, wherein the white mineral oil has a kinematic viscosity at 40° C. of 20 mm²/s to 330 mm²/s as measured according to the ASTM D 7279 standard, a flash point of 85° C. or higher, measured according to the ASTM D 92 standard, and a boiling point of 200° C. or higher measured according to the ASTM D 86 standard.

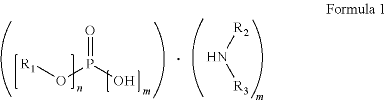

In Formula 1, each of R¹ to R³ independently be an alkyl group having 1 to 30 carbon atoms,

In Formula 1, each of n and m independently be 1 or 2, and a sum of n and m is 3.

According to some embodiments, the lubricant composition may include a friction-reducing agent and an antiwear agent. The antiwear agent is added to the lubricant composition for reducing wear and tear on the metal surfaces of the compression device. Although not wishing to be bound by theory the antiwear agent may form a protective layer on metal parts, preventing direct metal-to-metal contact under high-pressure conditions. This helps to extend the lifespan of the compression device and maintain its efficiency. Accordingly, the wear resistance of a compression device due to direct contact of the monomer with the compression device may be improved, thereby preventing damage to the compression device.

Therefore, the process stability may be improved by preventing defects such as plugging of polymerization equipment, and the polymerization efficiency and yield of the ethylene-based polymer may be increased.

### BRIEF DESCRIPTION OF THE DRAWINGS

The above and other objectives, features, and advantages of the embodiments of the present disclosure will be more clearly understood by those with ordinary skill in the art from the following detailed description taken in conjunction with the accompanying drawing.

FIG. 1 is a simplified schematic of a method of preparing an ethylene-based polymer according to an embodiment of the present disclosure.

### DETAILED DESCRIPTION

The embodiments of the present disclosure provide a lubricant composition including a base oil, a friction-reducing agent and an antiwear agent.

In addition, the embodiments of the present disclosure provide a method of preparing an ethylene-based polymer using the lubricant composition.

The term “(meth)acrylic acid,” as used herein may include both acrylic acid and methacrylic acid.

Likewise, the term “(meth)acrylate” as used herein may include both acrylate and methacrylate.

Hereinafter, the present invention will be described in detail through embodiments with reference to the accompanying drawings. However, the embodiments are merely illustrative and the present disclosure is not limited to the specific embodiments described, and it will be understood by those skilled in the art that the present disclosure is to cover all modifications, equivalents, and alternatives falling within the spirit and scope of the present disclosure.

A lubricant composition according to some embodiments may include a base oil, a friction-reducing agent and an antiwear agent.

The base oil may be included as a solvent of the lubricant composition. For example, the base oil may be included as a plasticizer, a diluent or media. Due to the base oil, an increase in friction inside polymerization equipment, a petrochemical facility, etc., and an increase in temperature and pressure inside the equipment caused by the increased friction may be prevented.

In some embodiments, the base oil may include a white mineral oil. The white mineral oil is a type of refined non-polar hydrocarbon. The white mineral oil may be composed of a mixture of saturated aliphatic and alicyclic nonpolar hydrocarbons. This means that the white mineral oil primarily consists of long-chain hydrocarbons that are fully saturated (containing only single bonds) and do not mix with water. These hydrocarbons are derived from petroleum and are highly refined to remove impurities, resulting in a colorless, odorless, and tasteless oil. The white mineral oil is applied to various industries such as pharmaceuticals, cosmetics, agriculture, and food due to a high stability thereof. For example, the white mineral oil may be included as the base oil. Employing the white mineral oil is advantageous because the lubricant composition may be suitably used in the preparation of a copolymer used in various industrial fields.

For example, the white mineral oil may have a viscosity (kinematic viscosity) at 40° C. of 20 mm²/s to 330 mm²/s, 50 mm²/s to 310 mm²/s, 50 mm²/s to 250 mm²/s, 100 mm²/s to 250 mm²/s, 100 mm²/s to 220 mm²/s, or 100 mm²/s to 150 mm²/s, or 100 mm²/s to 120 mm²/s. Within the above range, the lubricant composition and a monomer may come into uniform contact with each other. Accordingly, the friction reduction performance and polymerization inhibition performance may be enhanced. The viscosity may be measured according to the ASTM D 7279 standard.

In some embodiments, the white mineral oil may have a flash point of 85° C. or higher, 88° C. or higher, 90° C. or higher, 93° C. or higher, or 200° C. or higher. In some embodiments, the white mineral oil may have a flash point of 135° C. or lower, 130° C. or lower, 125° C. or lower, 120° C. or lower, or 115° C. or lower. The flash point may be measured according to the ASTM D 92 standard. Within the above range, the stability of the lubricant composition may be further improved.

In some embodiments, the white mineral oil may have a boiling point of 200° C. or higher, 210° C. or higher, 220° C. or higher, 230° C. or higher, or 300° C. or higher. In some embodiments, the white mineral oil may have a boiling point of 600° C. or lower, 550° C. or lower, 500° C. or lower, 450° C. or lower, 400° C. or lower. The boiling point may be measured according to the ASTM D 86 standard.

In some embodiments, the white mineral oil may have a density at 20° C. of 0.800 g/cm³ to 0.900 g/cm³, 0.820 g/cm³ to 0.900 g/cm³, 0.850 g/cm³ to 0.900 g/cm³, 0.850 g/cm³ to 0.890 g/cm³, or 0.860 g/cm³ to 0.890 g/cm³. Within the above range, the oxidation stabilizer may be more easily dissolved, and the oxidation stabilizer may come into more uniformly contact or be mixed with a radical reactive monomer. Accordingly, self-polymerization between the monomers by a radical active substance may be effectively inhibited. The density may be measured according to the ASTM D 4052 standard.

The base oil may be included as a balance of the lubricant composition except for the components described below.

The term “balance” as used herein indicates a variable amount that is adjusted depending on the components added. For example, the term “balance” as used herein may indicate an amount except for contents of components additionally included in the lubricant composition, such as a friction-reducing agent and an antiwear agent. The base oil can be included as the remainder of the lubricant composition, excluding the components listed below.

The friction-reducing agent is an amphiphilic substance that can reduce friction between the metals when they come into contact with each other. The friction-reducing agent may reduce friction between the metals by interacting a polar portion of the friction-reducing agent with the metal and arranging a nonpolar portion thereof outside the metal surface, for example. In this context, “the metals” refer to the metal surfaces within machinery or equipment that come into contact with each other during operation. These surfaces might include parts like gears, bearings, shafts, and other moving components. The friction-reducing agent helps to minimize the friction between these metal surfaces, ensuring smoother operation, reducing wear and tear, and improving the overall efficiency and longevity of the equipment.

In some embodiments, the friction-reducing agent may include oleic acid. The oleic acid is a type of fatty acid that can reduce friction due to contact between the metals.

In some embodiments, the friction-reducing agent may include stearic acid, linoleic acid, glyceryl trioleate and the like. The stearic acid and trioleic acid, which are types of fatty acids, may be included as the friction-reducing agent to reduce friction between the metals.

In some embodiments, a content of the friction-reducing agent may be 0.02% by weight (“wt %”) to 0.9 wt % based on a total weight of the lubricant composition. For example, the content of the oleic acid may be included in the lubricant composition within the above content ranges.

If the friction-reducing agent is included in a content of exceeding 0.9 wt % based on the total weight of the lubricant composition, effectiveness of each compound may be decreased due to a competitive reaction between the friction-reducing agent and the antiwear agent. In this case, a frictional heat of the equipment may promote the radical reactivity of the radical reactive monomer (for example, a polar monomer such as ethylene, carboxylic acid, (meth)acrylate, acetate, etc.), thereby causing the monomer to be self-polymerized. Therefore, defects such as a reduction in a lifespan of production equipment and clogging of a process device may occur.

If the content of the friction-reducing agent is less than 0.02 wt % based on the total weight of the lubricant composition, the friction-reducing agent may not be sufficiently applied to the metal surface, thereby causing a decrease in the wear resistance of the equipment. In this case, the frictional heat of the equipment may promote the radical reactivity of the radical reactive monomer (e.g., polar monomers such as ethylene, carboxylic acid, (meth)acrylate, acetate, etc.), thereby causing the monomer to be self-polymerized. Therefore, defects such as a reduction in lifespan of the production equipment and clogging of the process device may occur.

When the content of the friction-reducing agent is 0.02 wt % to 0.9 wt % based on the total weight of the lubricant composition, defects in the process device are prevented while friction within the equipment is effectively suppressed, such that the yield and process efficiency of the ethylene-based polymer may be improved.

In some embodiments, the content of the friction-reducing agent may be 0.09 wt % to 0.9 wt %, 0.1 wt % to 0.9 wt %, 0.1 wt % to 0.8 wt %, 0.1 wt % to 0.5 wt %, or 0.1 wt % to 0.3 wt %. For example, the content of the oleic acid may be included in the lubricant composition within the above content ranges. Within the above content ranges, defects of the process device may be more effectively prevented, and the yield and process efficiency of the ethylene-based polymer may be more improved.

In some embodiments, the antiwear agent may include a phosphoric acid compound. By using an antiwear agent including the phosphoric acid compound, wear caused by high-pressure friction of the process device, etc. may be reduced. Accordingly, process defects may be reduced, and process stability and process efficiency may be improved.

In some embodiments, the phosphoric acid compound may include an amine group. Thereby, the wear prevention performance of the antiwear agent including the phosphoric acid compound may be further improved. Accordingly, damage to the compression device may be further reduced, and process stability, polymerization efficiency of the ethylene-based polymer, and yield may be further improved.

In some embodiments, the phosphoric acid compound may include a compound represented by Formula 1 below.

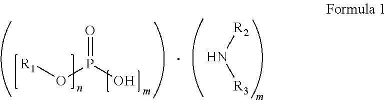

In Formula 1, each of R¹ to R³ may independently be an alkyl group having 1 to 30, 1 to 25, or 5 to 20 carbon atoms.

The term “alkyl group” as used herein includes both substituted and unsubstituted alkyl groups.

The term “substituted” as used herein may mean that at least one of the hydrogen atoms of the compound is substituted with a substituent such as a halogen group, a hydroxyl group, a heteroalkyl group, a heterocycloalkyl group, a heteroaryl group, an amine group, a nitrile group, a nitro group, a silyl group, etc.

The term “unsubstituted” as used herein may mean that all the hydrogen atoms of the compound are not substituted.

In Formula 1, n and m may be each independently 1 or 2, and a sum of n and m may be 3. For example, when n is 1, m may be 2. For example, when n is 2, m may be 1.

By including the compound represented by Formula 1 as the antiwear agent, the wear resistance of, for example, a compression device, etc. may be improved. Accordingly, process defects may be prevented.

In some embodiments, the content of the antiwear agent may be 0.01 wt % to 0.5 wt %, 0.03 wt % to 0.5 wt %, or 0.03 wt % to 0.4 wt % based on the total weight of the lubricant composition. For example, the phosphoric acid compound may be included in the lubricant composition within the above content ranges. Within the above content ranges, damage to the compression device that can occur when the radical reactive monomer directly comes into contact with the compression device under high pressure conditions through the antiwear agent may be reduced. Accordingly, process stability may be improved.

In an embodiment, the content of the antiwear agent may be 0.1 wt % to 0.4 wt %, 0.2 wt % to 0.4 wt %, or 0.25 wt % to 0.35 wt % based on the total weight of the lubricant composition. For example, the phosphoric acid compound may be included in the lubricant composition within the above content ranges. Within the above content ranges, damage to the compression device may be further reduced through the antiwear agent. Accordingly, process stability may be further improved.

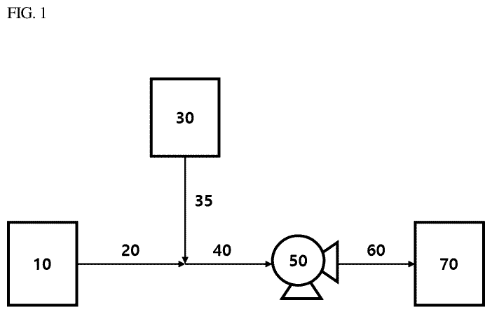

FIG. 1 is a simplified schematic of a method of preparing an ethylene-based polymer according to an embodiment of the present disclosure.

Referring to FIG. 1, a first monomer including an ethylene monomer may be supplied from a first monomer supply unit 10. For example, the first monomer may be moved from the first monomer supply unit 10 to a compression device 50 through a first flow path 20.

In an embodiment, an additive such as a stabilizer, a reaction inhibitor, etc. may be supplied together with the first monomer. For example, the stabilizer and the reaction inhibitor may include at least one selected from the group of a primary antioxidant including a phenolic or amine-based substance and a secondary antioxidant including a phosphorus or sulfur-based substance.

In some embodiments, a second monomer including a comonomer may be supplied from a second monomer supply unit 30. For example, the second monomer may be supplied as a comonomer from the second monomer supply unit 30. For example, the second monomer may be moved through a second flow path 35 and come into contact with the first monomer supplied through the first flow path 20.

The second monomer including the comonomer may include a carboxylic acid monomer, a (meth)acrylate monomer, or an acetate monomer of which a chain polymerization reaction is possible. For example, the comonomer may include at least one selected from the group consisting of a carboxylic acid monomer, a (meth)acrylate monomer and an acetate monomer.

In some embodiments, (meth)acrylic acid may be used as the carboxylic acid monomer. In some embodiments, (meth)acrylate or alkyl (meth)acrylate may be used as the (meth)acrylate monomer. In some embodiments, vinyl acetate may be used as the acetate monomer.

A mixture of the first monomer and the second monomer may be moved to the compression device 50 through an injection flow path 40 and discharged through a discharge flow path 60 to be injected into a reactor 70 for polymerization/copolymerization. For example, a first monomer including an ethylene monomer may be injected into the reactor 70 through the compression device 50 as a monomer for preparing an ethylene-based polymer. For example, a second monomer including at least one selected from the group consisting of a carboxylic acid monomer, a (meth)acrylate monomer, and an acrylate monomer may be injected into the reactor 70 through the compression device 50 as a comonomer for preparing an ethylene-based polymer.

The compression device 50 may include, for example, discharge equipment such as a pump, a compressor, etc. The above-described lubricant composition may be injected into the compression device 50.

For example, the compression device 50 may include a cylinder structure such as a piston and a bushing which surrounds the piston. The above-described lubricant composition may be injected into a gap between the piston and the cylinder structure.

As friction occurs repeatedly between the piston and the cylinder structure inside the gap, if a local polymerization temperature exceeds a predetermined level due to frictional heat, a self-polymer such as poly(acrylic acid (PAA) may be generated, for example. The gap may be clogged by the self-polymer, thereby shortening an exchange cycle or cleaning cycle of the compression device 50. Accordingly, the process efficiency may be reduced, and the yield of the ethylene-based polymer may be decreased.

According to some embodiments, the above-described lubricant composition is used such that friction is reduced even under high temperature and high pressure conditions, and thus self-polymerization of the monomer due to frictional heat may be suppressed. Accordingly, the exchange cycle or cleaning cycle of the compression device 50 may be increased, and the equipment lifespan may be improved.

According to some embodiments, the monomer for preparing an ethylene-based polymer may be reacted in the reactor 70 to prepare the ethylene-based polymer. For example, the first monomer including an ethylene monomer and the second monomer including a comonomer may be reacted in the reactor 70 to prepare the ethylene-based polymer.

In some embodiments, an internal temperature of the compression device 50 may be lower than an internal temperature of the reactor 70. For example, the internal temperature of the compression device 50 may be 20° C. to 120° C., or 30° C. to 120° C., or 30° C. to 100° C. For example, the internal temperature of reactor 70 may be 150° C. to 270° C., 180° C. to 270° C., or 180° C. to 250° C.

For example, a copolymerization pressure inside the reactor 70 may be 1,100 bar to 2,500 bar, 1,300 bar to 2,500 bar, or 1,300 bar to 2,300 bar. For example, a discharge pressure from the compression device 50 to the reactor 70 may be 2,000 bar to 3,500 bar, 2,300 bar to 3,500 bar, or 2,300 bar to 3,000 bar.

In some embodiments, the discharge pressure from the compression device 50 to the reactor 70 may be greater than the copolymerization pressure inside the reactor 70. For example, within the above pressure range, the discharge pressure from the compression device 50 to the reactor 70 may be greater than the copolymerization pressure inside the reactor 70.

In some embodiments, the ethylene-based polymer may include at least one selected from the group consisting of an ethylene-carboxylic acid copolymer, an ethylene-(meth)acrylate copolymer, an ethylene acetate copolymer and polyethylene.

For example, when ethylene is used as the first monomer and the second monomer is not used, polymerization between ethylene monomers may be performed in the reactor 70 to prepare polyethylene.

For example, an ethylene monomer may be used as the first monomer and a carboxylic acid monomer may be used as the second monomer. Copolymerization of the ethylene monomer and the carboxylic acid monomer may be performed in the reactor 70 to prepare an ethylene-carboxylic acid copolymer (e.g., an ethylene-acrylic acid (EAA) copolymer).

For example, the ethylene monomer may be used as the first monomer, and a (meth)acrylate monomer may be used as the second monomer. Copolymerization of the ethylene monomer and the (meth)acrylate monomer may be performed in the reactor 70 to prepare an ethylene-(meth)acrylate copolymer (e.g., an ethylene-acrylate (EA) copolymer).

For example, the ethylene monomer may be used as the first monomer, and an acetate monomer may be used as the second monomer. Copolymerization of the ethylene monomer and the acetate monomer may be performed in the reactor 70, such that an ethylene-acetate copolymer, e.g., an ethylene vinyl acetate (EVA) copolymer may be prepared.

In some embodiments, a chain transfer agent may be added during the copolymerization process. A molecular weight and molecular weight distribution of the polymer product may be easily controlled within a desired range through the chain transfer agent. The chain transfer agent may include, for example, a nonpolar organic compound such as isobutane or propene, etc., or a polar organic compound such as methyl ethyl ketone or isopropylaldehyde.

Hereinafter, embodiments provided in the present disclosure will be further described with reference to specific experimental examples. However, the following experimental examples only illustrate the embodiments and are not intended to limit the appended claims, and those skilled in the art will understand that various alterations and modifications are possible within the scope and spirit of the present disclosure. Such alterations and modifications are duly included in the appended claims. Furthermore, the embodiments may be combined to form additional embodiments.

### EXAMPLES AND COMPARATIVE EXAMPLES

### Example 1

A lubricant composition was prepared by mixing 99.6 wt % of white mineral oil, as a base oil, 0.1 wt % of oleic acid as a friction-reducing agent, and 0.3 wt % of a phosphoric acid compound (Irgalube 349, BASF) as an antiwear agent.

### Examples 2 to 5 and Comparative Examples 1 to 5

Lubricant compositions were prepared in the same manner as in Example 1, except that the contents of the base oil (white mineral oil), the friction-reducing agent (oleic acid), and the antiwear agent (Irgalube 349) were changed as listed in Table 1 below.

TABLE 1

| | Component of lubricant composition | | |
|---|---|---|---|
| | White | Oleic | |
| | mineral oil | acid | Irgalube 349 |
| Item | (wt %) | (wt %) | (wt %) |
| Example 1 | 99.6 | 0.1 | 0.3 |
| Example 2 | 99.4 | 0.1 | 0.5 |
| Example 3 | 99.8 | 0.1 | 0.1 |
| Example 4 | 99.87 | 0.1 | 0.03 |
| Example 5 | 98.9 | 0.8 | 0.3 |
| Comparative | 97 | 3 | 0 |
| example 1 | | | |
| Comparative | 98.5 | 1 | 0.5 |
| example 2 | | | |
| Comparative | 99.5 | 0 | 0.5 |
| example 3 | | | |
| Comparative | 99.685 | 0.015 | 0.3 |
| example 4 | | | |
| Comparative | 99.695 | 0.005 | 0.3 |
| example 5 | | | |

### Experimental Example: Evaluation of Wear Resistance

Wear resistances of the lubricant compositions prepared according to the examples and comparative examples were evaluated. The wear resistance was determined by measuring a wear diameter (Wear Scar Diameter, WSD) using a 4-ball wear tester according to the ASTM D 4172-94 standard.

Measurement results are shown in Table 2 below.

TABLE 2

| | WSD |
|---|---|
| Item | (mm) |
| Example 1 | 0.333 |
| Example 2 | 0.683 |
| Example 3 | 0.405 |
| Example 4 | 0.433 |
| Example 5 | 0.388 |
| Comparative example 1 | 0.833 |
| Comparative example 2 | 1.438 |
| Comparative example 3 | 1.299 |
| Comparative example 4 | 1.216 |
| Comparative example 5 | 1.299 |

Referring to Tables 1 and 2, in the examples where oleic acid was included as the friction-reducing agent in an amount of 0.02 wt % to 0.9 wt % based on the total weight of the lubricant composition, the WSD was 0.683 mm or less.

In Example 2 where the content of the antiwear agent (phosphoric acid compound; Irgalube 349) was increased, the WSD was increased compared to Example 1.

In Examples 3 and 4 where the content of the antiwear agent (phosphoric acid compound; Irgalube 349) was decreased, the WSD was increased compared to Example 1.

In Example 5 where the content of the friction-reducing agent (oleic acid) was increased, the WSD was increased compared to Example 1.

In comparative examples where the oleic acid was included as a friction-reducing agent in an amount less than 0.02 wt % or greater than 0.9 wt % based on the total weight of the lubricant composition, the WSD was increased.

### DESCRIPTION OF REFERENCE NUMERALS

10: First monomer supply unit
20: First flow path
30: Second monomer supply unit
35: Second flow path
40: Injection flow path
50: Compression device
60: Discharge flow path
70: Reactor

What is claimed is:

1. A lubricant composition comprising:
a base oil;
a friction-reducing agent which comprises oleic acid; and
an antiwear agent which comprises a phosphoric acid compound,
wherein a content of the friction-reducing agent is 0.02% by weight to 0.9% by weight based on a total weight of the lubricant composition.

2. The lubricant composition according to claim 1, wherein the base oil comprises a white mineral oil.

3. The lubricant composition according to claim 1, wherein the content of the friction-reducing agent is 0.1% by weight to 0.8% by weight based on the total weight of the lubricant composition.

4. The lubricant composition according to claim 1, wherein the phosphoric acid compound comprises an amine group.

5. The lubricant composition according to claim 4, wherein the phosphoric acid compound comprises a compound represented by Formula 1 below: 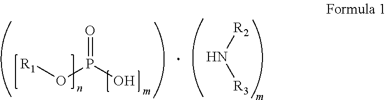
wherein in Formula 1, each of R₁ to R₃ independently is an alkyl group having 1 to 30 carbon atoms,
wherein each of n and m independently is 1 or 2, and
wherein a sum of n and m is 3.

6. The lubricant composition according to claim 1, wherein a content of the antiwear agent is 0.01% by weight to 0.5% by weight based on the total weight of the lubricant composition.

7. The lubricant composition according to claim 6, wherein the content of the antiwear agent is 0.2% by weight to 0.4% by weight based on the total weight of the lubricant composition.

8. A method of preparing an ethylene-based polymer comprising:
injecting the lubricant composition according to claim 1 into a compression device;
moving a monomer for preparing an ethylene-based polymer which comprises an ethylene monomer to a reactor through the compression device; and
reacting the monomer for preparing an ethylene-based polymer in the reactor.

9. The method of preparing an ethylene-based polymer according to claim 8, wherein the monomer for preparing an ethylene-based polymer further comprises at least one selected from the group consisting of a carboxylic acid monomer, a (meth)acrylate monomer and an acetate monomer.

10. The method of preparing an ethylene-based polymer according to claim 8, wherein the ethylene-based polymer comprises at least one selected from the group consisting of an ethylene-carboxylic acid copolymer, an ethylene-(meth)acrylate copolymer, an ethylene-acetate copolymer and polyethylene.

11. A lubricant composition comprising:
a base oil comprising a white mineral oil;
a friction-reducing agent which comprises oleic acid; and
an antiwear agent which comprises a phosphoric acid compound having the following Formula 1, 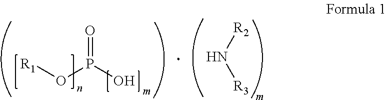
wherein in Formula 1, each of R₁ to R₃ independently is an alkyl group having 1 to 30 carbon atoms,
wherein each of n and m independently is 1 or 2, and
wherein a sum of n and m is 3,
and wherein the white mineral oil has a kinematic viscosity at 40° C. of 20 mm²/s to 330 mm²/s as measured according to the ASTM D 7279 standard, a flash point of 85° C. or higher, measured according to the ASTM D 92 standard, and a boiling point of 200° C. or higher measured according to the ASTM D 86 standard.
